(19) United States
(12) Patent Application Publication
(10) Pub. No.: US 2003/0022033 A1
(43) Pub. Date: Jan. 30, 2003

(54) Fuel cell with pulsed anode potential

(75) Inventors: Ulrich Stimming, Munich (DE); Kaspar Andreas Friedrich, Munich (DE); Wolfgang Unkauf, Turkenfeld (DE)

Correspondence Address: COHEN, PONTANI, LIEBERMAN & PAVANE, Suite 1210, 551 Fifth Avenue, New York, NY, 10176, US

(73) Assignee: Mannesmann AG

(21) Appl. No.: 10/054,213

(22) Filed: Nov. 13, 2001

Related U.S. Application Data
(63) Continuation-in-part of application No. 09/381,113, filed on Oct. 15, 1999, now abandoned.

(30) Foreign Application Priority Data
Mar. 15, 1997 (DE) 197 10 819.9

(51) Int. Cl. H01M 8/00; H01M 8/06

(52) U.S. Cl. 429/12; 429/13; 429/17

(57) ABSTRACT

A fuel cell having an electrode-electrolyte unit, with an anode catalyst via which the catalytic activity in the fuel cell is reduced by carbon monoxide. An arrangement for varying the anode potential in a pulsed manner such that carbon monoxide adsorbed at the catalyst is also provided. In this way, power losses caused by carbon monoxide adsorptions at the anode catalyst are reduced.

### BACKGROUND OF THE INVENTION

1. Field of the Invention

The invention concerns a fuel cell.

2. Discussion of the Prior Art

fuel cell has a cathode, an electrolyte and an anode. The cathode is supplied with an oxidizing agent, for example air, and the anode is supplied with a fuel, for example hydrogen.

There are fuel cells in which the electrolyte comprises a proton-conducting membrane. The operating temperature of such fuel cells is up to 130° C. In the presence of the fuel, hydrogen ions form at the anode by means of a catalyst. The hydrogen ions pass the electrolyte and bond on the cathode side with the oxygen ions originating from reduction of oxygen to form water. Electrons are thereby released and consequently electrical energy is generated.

During the operation of fuel cells, which comprise for example noble metal catalysts such as Pt as the active component of the electrodes, even very low concentrations of carbon monoxide in the fuel (<50 ppm) lead to a reduction in the power of the cell, because active catalyst locations are occupied by adsorbed carbon monoxide and are blocked. This problem occurs particularly badly in the case of fuel cells which have a polymeric solid electrolyte.

Methanol is frequently provided as the energy-transmission medium for fuel cells with polymeric solid electrolytes and is converted in a reforming reaction with water into a hydrogen-rich synthesis gas. This synthesis gas contains about 1% carbon monoxide. The relatively high proportion of CO in the synthesis gas leads to a drastic deactivation of the electrocatalyst of the anode of the fuel cell and reduces the power of the fuel cell.

The deactivation of the catalysts likewise occurs when using a combustion gas, which is produced by reforming alcohols, hydrocarbons and mixtures of hydrocarbons. The reforming of the energy-transmission medium may take place externally or internally, as described in the publication reviewing fuel cell technology by U. Stimming, VDI Berichte No. 1174, (1995). It is also known that a reduction in the power of fuel cells due to deactivation of the anode catalysts also occurs in the case of direct methanol conversion at the anode of the fuel cell due to the production of CO.

For avoiding the aforementioned deactivation of catalysts, it is known to reduce the CO content of the fuels below 100 ppm by gas cleaning. However, secondary cleaning is complex and consequently costly.

It is also known to develop anode catalysts with improved CO resistance, such as Pt—Ru alloys for example. Such catalysts are, however, likewise very expensive. Adsorption effects, and associated power losses, can also be reduced only to an unsatisfactory extent.

It is known from the publication by S. Gottesfeld and J. Pafford, J. Electrochem. Soc. 135 (1988) 2651, to avoid deactivations caused by adsorbed carbon monoxide by adding low concentrations of oxygen or air to the fuel. A disadvantage of this solution is that ignitable mixtures may occur.

### SUMMARY OF THE INVENTION

The present object of the present invention is to provide a fuel cell in which power losses caused by contaminants adsorbed at the anode catalyst can be avoided inexpensively and reliably.

Pursuant to this object, and others which will become apparent hereafter, one aspect of the present invention resides in a fuel cell having an anode-cathode unit which includes an anode catalyst and means which impress a positive voltage pulse on the anode of a fuel cell are provided. A pulsed variation of the anode potential is brought about by the impressing of said pulse. The fuel cell has a voltage that does not change sign and at most becomes zero so that voltage U (fuel cell)−U (cathode)−U (anode) >0.

The improvement in the power is achieved by oxidation of the carbon monoxide adsorbed at the catalyst by means of the pulsed variation of the anode potential. The magnitude of the voltage of the voltage pulse is consequently to be chosen during operation such that carbon monoxide adsorbed at the anode catalyst is oxidized.

To produce a suitable positive voltage pulse, means which produce a temporary short circuit between the anode and cathode are provided for example. Alternatively, means which bring about a pulsed feeding in of external electrical energy, which is supplied to the anode, are provided. In both cases, short current or voltage pulses are produced and impressed on the anode. The pulse may in principle be of any desired shape. The variant first described, with the short circuit, has the advantage over the feeding in of external energy in that there is no need for an external energy source.

For the pulsed variation of the anode potential, a control device for a suitable, fast transistor switch is used, for example. The transistor switch either briefly shorts the contaminated fuel cell for a defined time or changes the anode potential to positive values, in that an external DC voltage source of about 1 V (e.g. a battery), applied via the switch, is impressed on the cell for a defined time.

The coupling in of the current or voltage pulses has the effect that contaminants adsorbed on the anode catalyst are oxidized and, as a consequence, the cell is reactivated. Since the reactivation takes place considerably faster than the deactivation, an average increase in power is the consequence in the case of fuel with carbon monoxide fractions. This applies in particular when catalysts with improved CO resistance, such as Pt—Ru alloys, are used.

Preferred time periods for the pulses are 10 to 200 milliseconds. The electric currents are generally several A/cm² (e.g. up to 10 A/cm²).

If a fuel cell is operated under constant load, repetition rates of 0.01-0.5 Hz are to be preferred. In cases of load changes, a corresponding variation of the repetition times of the pulses is expedient.

The power losses of a fuel cell caused by the operation of an electronic device for generating the voltage or current pulses, that is the power losses caused by the interruption in the removal of energy during the time period of a pulse as well as the power losses caused by the energy expended for the pulse, are at most 1-5% of the power generated by the cell.

### BRIEF DESCRIPTION OF THE DRAWINGS

FIG. 1 shows a schematic representation of a fuel cell arrangement pursuant to the present invention; and

FIG. 2 is a plot showing the variation in electric current at an anode plotted against time.

### DETAILED DESCRIPTION OF THE PREFERRED EMBODIMENTS

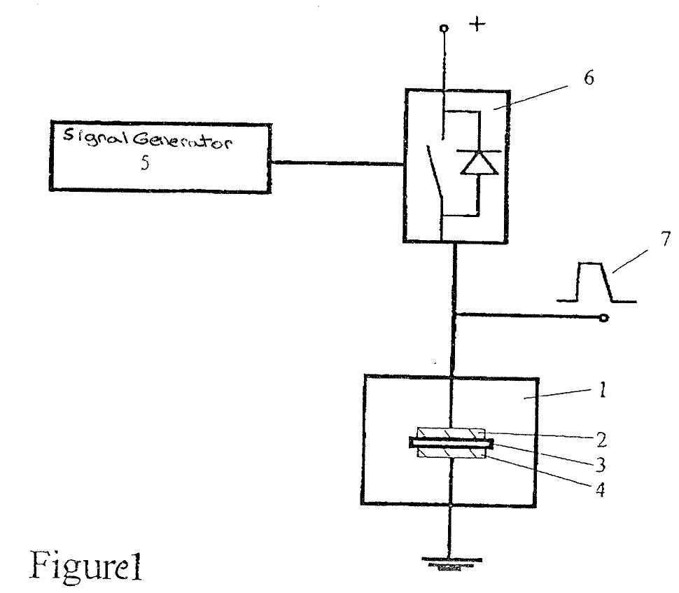

FIG. 1 shows a fuel cell 1, an anode 2, an electrolyte layer 3 and a cathode 4. A signal generator 5 is provided as a control device. The signal generator 5 controls a fast high-power transistor switch, to be precise a transistor MOSFET 6 for generating voltage pulses 7. The transistor MOSFET 6 is electrically connected to the anode 2, so that a pulsed variation of the anode potential is produced. The variation is such that carbon monoxide adsorbed at the anode catalyst can be oxidized.

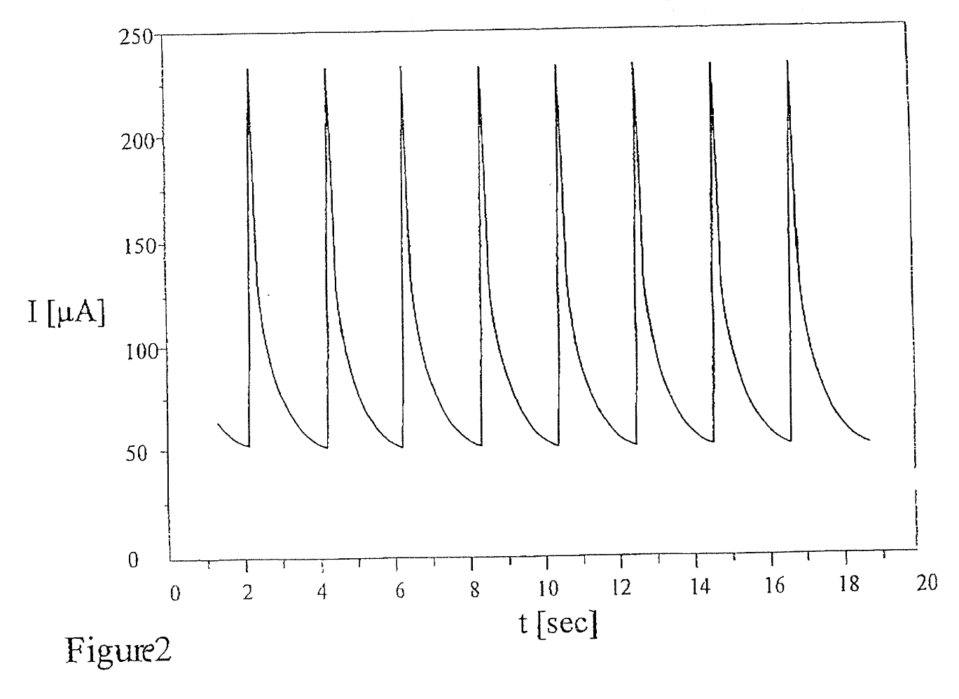

FIG. 2 shows the variation in electric current I at an anode plotted against time t, as produced according to the invention in a fuel cell. A carbon-supported Pt/Ru alloy catalyst was used at a potential of 200 mV with H₂/5% CO gas mixtures being supplied. By periodic coupling in of potentiostatic pulses with an amplitude of 700 mV and a pulse duration of 100 ms at a repetition rate of 0.1 Hz, a current can be continuously maintained. The coupled-in pulse brings about a potential of 900 mV with respect to hydrogen potential in a step-change manner. Such a step potential is sufficient for bringing about the desired oxidation of the adsorbed carbon monoxide. In the present example, the current is at least 50 μA for longer than one hour. Such a continuous oxidation current at the anode of the fuel cell permits constant operation and a considerable increase in power of the cell in comparison with operation without the coupling in of pulses.

Reformed alcohols and reformed hydrocarbons can be used as fuel for the fuel cell. The alcohols and the hydrocarbons can be reformed internally in the fuel cell. Direct conversion of the alcohols and the hydrocarbons takes place at the anode.

We claim:

1. A fuel cell, comprising:
an anode-electrolyte-cathode unit having an anode catalyst; and
means for impressing a positive voltage pulse on the anode, whereby the fuel cell have a voltage that does not change sign and at most becomes zero so that U (fuel cell)=U (cathode)−U (anode)>0.

2. A method for removing carbon monoxide from an anode catalyst of a fuel cell comprising the step of impressing at least one positive voltage pulse on the anode, whereby the fuel cell has a voltage that does not change sign and at most becomes zero so that U (fuel cell)=U (cathode)−U (anode)>0.

3. A method as defined in claim 2, including impressing repeated positive voltage pulses on the anode.

4. A method as defined in claim 2, further including using reformed alcohols as fuel.

5. A method as defined in claim 2, further including using reformed hydrocarbons as fuel.

6. A method as defined in claim 4, including reforming the alcohols internally in the fuel cell.

7. A method as defined in claim 5, including reforming the hydrocarbons internally in the fuel cell.

8. A method as defined in claim 2, wherein a direct conversion of alcohols takes place at the anode.

9. A method as defined in claim 2, wherein a direct conversion of hydrocarbons takes place at the anode.
